(19) United States
(12) Patent Application Publication
(10) Pub. No.: US 2007/0160273 A1
(43) Pub. Date: Jul. 12, 2007

(54) Device, system and method for modifying two dimensional data of a body part

(76) Inventors: Adi Maschiah, Tel Aviv (IL); Shmuel Banai, Ramat Bet HaKerem (IL)

Correspondence Address: PEARL COHEN ZEDEK LATZER, LLP, 1500 BROADWAY 12TH FLOOR, NEW YORK, NY, 10036, US

(21) Appl. No.: 11/328,191

(22) Filed: Jan. 10, 2006

(51) Int. Cl. G06K 9/00

(52) U.S. Cl. 382/128

(57) ABSTRACT

A method, system and set of instructions for acquiring a three dimensional image of a first part of a blood vessel that is free of contrast material; acquiring a two dimensional image of a part of the blood vessel, that is highlighted by contrast material; producing from the three dimensional image, a two dimensional image of the part of the blood vessel that is not highlighted by contrast material; and combining image data of both two dimensional images.

### FIELD OF THE INVENTION

Embodiments of the invention relate to the modification of image data from a two dimensional image of for example a body part, with image data from a three dimensional image of the body part. For example, embodiments of the invention may combine image data produced by an angiogram with image data produced by for example a computer tomography scan.

### BACKGROUND OF THE INVENTION

Intra-operative imaging procedures such as for example angiography may produce a two dimensional (2D) image of a body part such as for example a blood vessel or a vessel tree. Pre-operational imaging procedures such as those that may be provided by for example computer tomography, magnetic resonance imaging or other modalities may provide three dimensional (3D) images of the body part. In preparation for a procedure on a heart, it is often desirable to study a 3D image of the heart, such as for example data on a vessel tree in the heart, so that a practitioner may be aware of the 3D structure of for example a vessel tree, when he views a 2D intra-operative image.

### SUMMARY OF THE INVENTION

In some embodiments, a system, method or device may acquire a three dimensional image of a first part of a blood vessel being free of contrast material or not highlighted by contrast material, may acquire a two dimensional image of a another part of the blood vessel, that is highlighted by contrast material, may produce a two dimensional image of the part that is or is not highlighted from the three dimensional image where the perspective of the non-highlighted part in the two dimensional image of matches the perspective of the two dimensional image of the highlighted part, and may combine image data of the two dimensional image of the highlighted part with image data from the two dimensional image of the non-highlighted part. In some embodiments, the modified image data may be displayed. In some embodiments, a probe or instrument or a position of the probe or instrument that may be inserted into a blood vessel may be displayed or represented in for example the modified image data.

In some embodiments, the three dimensional image may be captured in a pre-operative period, and the two dimensional image of the highlighted part may be captured in an inter-operative period. In some embodiments the three dimensional image and the two dimensional image of the highlighted part may be captured during a preoperative period.

In some embodiments, an angle of the unit that captures the two dimensional image of the highlighted part may be recorded, as for example relative to the vessel or body part that is being imaged. In some embodiments the angel may be recorded in for example a DICOM format.

In some embodiments, producing a two dimensional image of the part that is free from contrast material or not highlighted by contrast material may include producing many two dimensional images of the not highlighted part, as may be needed to correspond to many possible perspectives of the two dimensional image that may be captured of the highlighted part. In some embodiments, a highlighted part of a vessel in one image may be not-highlighted in another image.

In some embodiments, the two dimensional images may be registered over each other.

### BRIEF DESCRIPTION OF THE DRAWINGS

Embodiments of the invention will be understood and appreciated more fully from the following detailed description taken in conjunction with the drawings in which:

FIG. 1A is a schematic diagram of components of an examination and/or imaging device with a processor, in accordance with an embodiment of the invention;

FIG. 1B is a schematic diagram of an examination and/or 3D imaging device, in accordance with an embodiment of the invention;

FIG. 2. is a conceptual illustration of a 3D image and one or more 2D images in accordance with an embodiment of the invention; and

FIG. 3 is a flowchart of an embodiment of the method in accordance with an embodiment of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention. Various examples are given throughout this description. These are merely descriptions of specific embodiments of the invention. The scope of the invention is not limited to the examples given.

Unless specifically stated otherwise, as apparent from the following discussions, it is appreciated that throughout the specification, discussions utilizing terms such as “processing,” “computing,” “calculating,” “determining,” “comparing” or the like, refer to the action and/or processes of a processor, computer or computing system, or similar electronic or hardware computing device, that manipulates and/or transforms data represented as physical, such as electronic quantities within the computing system's registers and/or memories into other data similarly represented as physical quantities within the computing system's memories, registers or other such information storage, transmission or display devices.

In some embodiments, the term ‘free of contrast material’ or ‘not highlighted by contrast material’ may, in addition to the regular understanding of such term, mean having contrast material in quantities that are insufficient to provide a clear or visibly distinct definition of the boundaries of the lumen of a vessel wherein such contrast material may be found. In some embodiments, the term ‘free of contrast material’ may mean that a contrast material was not administered.

The processes and displays presented herein are not inherently related to any particular computer, processor or other apparatus. The desired structure for a variety of these systems will appear from the description below. In addition, embodiments of the present invention are not described with reference to any particular programming language, machine code, etc. It will be appreciated that a variety of programming languages, machine codes, etc. may be used to implement the teachings of the invention as described herein. Embodiments of the invention may be included on a medium or article such as a hard disc, disc on key or other memory unit having stored thereon machine-accessible instructions that when executed result in or implement an embodiment of the invention.

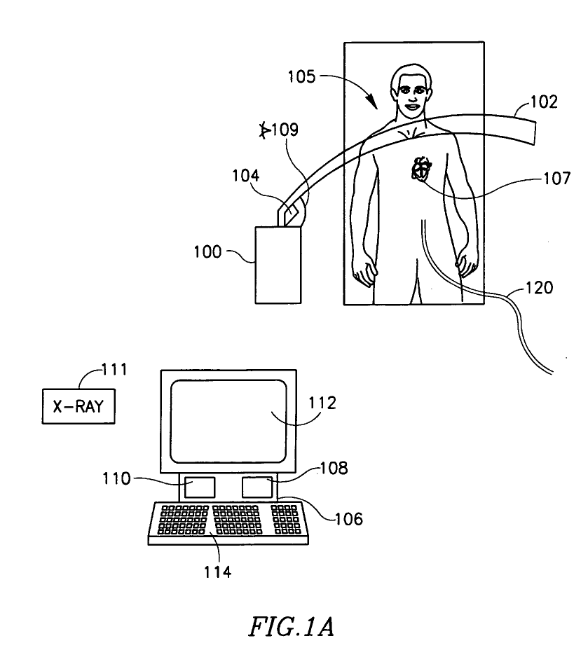

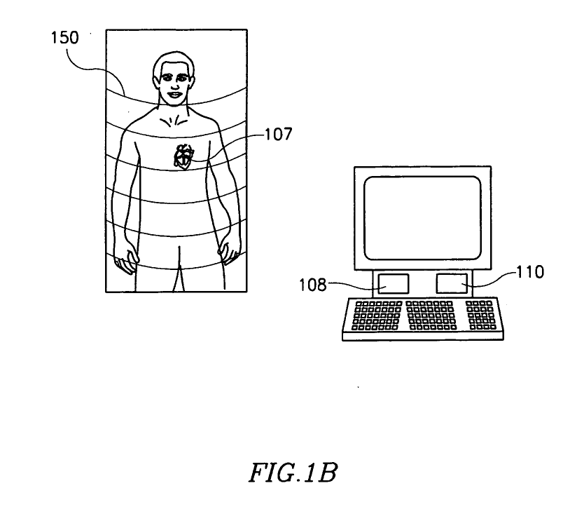

Reference is made to FIG. 1A, a schematic diagram of components of one or more examination and/or imaging devices with a processor in accordance with an embodiment of the invention. A data acquisition device, such as for example an imager such as for example 2D imager 100, such as for example an angiograph or other imager, may obtain 2D images such as for example X-ray 111, or 2D images provided by another imaging modality. Other processes for generating a 2D image such as for example ultrasound, MRI or the like are possible. The 2D imager 100 may be equipped with for example a C-arm 102 on which an X-ray 111 source and a radiation detector such as for example a solid state detector may be mounted or to which it may be attached or otherwise connected. Other 2D image detectors may be used. In some embodiments, the field of examination of a body part 107 of interest of a patient 105 may be located at for example an isocenter of the C-arm 102. Other placements of the body part 107 are possible. In some embodiments, the position of C-arm 102, and for example an angle 109 of the C-arm 102 and the 2D images captured by imager 100 of the body part 107 of interest, may be detected and/or recorded by an angle recorder 104 of the C-arm 102. In some embodiments, such angle 109 may be recorded in a Digital Imaging and Communications in Medicine (DICOM) format along with the images captured by the 2D imager 100, such that in some embodiments, an image is correlated or stored in connection with an angle of for example the C-arm 102 such that the position of the C-arm relative to body part 107 in the image may be known. Other procedures and formats for capturing and recording an angle 109 of an image or of a 2D imager 100 relative to an organ or body part 107 or to another point or reference may be used.

In some embodiment an angle of for example a 2D imager may include one or more of an anterior—oblique angle such as a left anterior—oblique (LAO) angle or a right anterior—oblique angle (RAO), or for example a cranial-caudal angle. Other angles are possible, and a combination of angles are possible such that images may be generated for various permutations and combinations of sets of angles.

In some embodiments, a probe 120 may be inserted into a patient 105 by way of for example a blood vessel, and such probe 120 may be maneuvered into for example a body part 107 that is being imaged.

A device 106 may be, may include or may be connected to one or more controllers, processors 108 and/or memory or data storage units 110 that may contain, store and/or process among other things an image of a body part 107 or other area of interest. In some embodiments, processor 108 may be included in or connected to for example one or more display 112 systems, screens, printers or other devices for exhibiting or generating visible manifestations of an image such as for example a 2D image, a 3D image or other image. In some embodiments processor 108 may be, may be included in or connected to an input device 114 such as for example a pointer, keyboard or other control device through which a user may manipulate an imager 100 or otherwise designate image data, an image, a portion of an image or other data.

Reference is made to FIG. 1B, a schematic diagram of an examination and/or 3D imaging device, in accordance with an embodiment of the invention. In some embodiments a 3D image of a body part 107 may be captured during for example a pre-operative procedure by a 3D imager 150 such as a computer tomography (CT) scan, magnetic resonance imaging (MRI), or other imaging modality. 3D images may be generated at other times such as for example in pre-operative period, or at some other period such as for example an intra-operative period. The 3D image may be stored for example on a memory or data storage unit 110 that may be linked to processor 108.

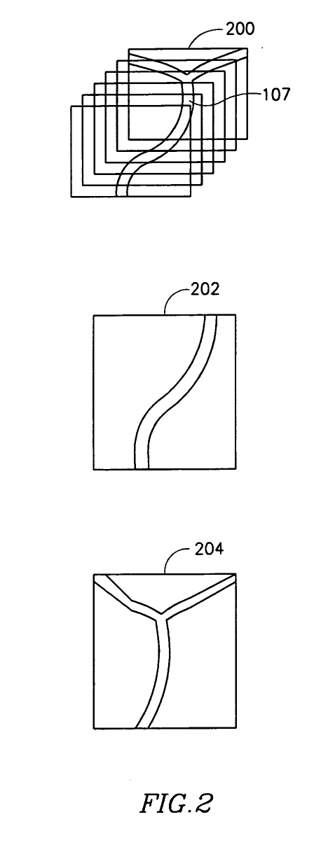

Reference is made to FIG. 2, a conceptual illustration of a 3D image or series of images and one or more 2D images in accordance with an embodiment of the invention. In operation, a practitioner, such as for example a doctor, imaging technician or other user, may capture, for example a 3D image 200 of an organ, a body part 107 or other interest area, such as for example a heart or segment of a heart or blood vessel in a heart or elsewhere in a body. The 3D image 200 may be captured and stored in for example storage unit 110. A user may also capture a 2D image 202 of the body part 107, and such 2D image 202 may be captured at an angle to the body part 107 as may for example be selected by the user. In some embodiments, the selected angle or perspective of the 2D image 202 of body part 107 may, for example be or include an angle that highlights or displays one or more features of the body part 107 that for example a doctor may desire to observe during for example a procedure undertaken on the organ or body part 107. Processor 108 may generate or select a second 2D image 204 based on or derived from the image data of the 3D image 200, where the angle, perspective or view of the organ or body part in the second 2D image 204 matches, is similar to or is the same as the angle or perspective of the view of the organ, as was selected by the user in capturing the first 2D image 202. Data, such as image data from the second 2D image 204 may be added to, combined with or otherwise used to modify the first 2D image 202, or for example to modify image data from the first 2D image 202.

In some embodiments, a user may angle an angiograph or other 2D imager 100 to capture a 2D image of for example a heart, blood vessel or other body part, by setting for example a C-arm 102 at an angle of for example 30°RAO-15° cranial-caudul, to a body part 107 so that for example a particular vessel or body part is visible or otherwise present in the image data of the 2D image 202 captured by the 2D imager 100. In some embodiments, an angle of an imager such as for example an angle of a C-arm 102 of an angiograph may be calculated from 3D image data, and such angle may allow a user to optimize a view of a body part. In some embodiments, a preferred or optimized angle of a view of a body part may be derived from for example a comparison of an entropy dimension of one or more views. Processor 108 may select or generate a second 2D image 204 based on for example a previously collected the 3D image 200, where an angle, view or perspective of such second 2D image 204 is similar to, includes or is the same as the view that the user is seeing in the 2D image 202 that may have been captured by the 2D imager 100. In some embodiments the image data present in the second 2D image 204 may be added to, combined with or used to enhance or otherwise modify the image or image data of for example, the angiograph image or second 2D image 204.

For example, the 2D image 202 such as for example an angiograph or other image of a vessel or part of a vessel may in some embodiments display or include image data of a part of for example one or more cardiac arteries or vessel trees. In some embodiments, 2D image 202 may capture image data of for example a part of a vessel that is highlighted by for example contrast material. A 3D image 200 that may include the image data of the same artery or a different part of the artery may include or define features of the artery, or may include image data about parts of the artery or vessel, where such features or parts were not highlighted by or are free of contrast material. In some embodiments, features or parts of for example a vessel or body part 107 that are not evident in or that do not appear in 2D image 202 may appear in 2D image 204. In some embodiments, 2D image 202 may be enhanced, supplemented or combined with some or all of the image data in 2D image 204 to include the image data in the 2D image 204 that did not appear in 2D image 202. The supplemental, enhanced or combined data from for example 2D image 204 may be presented or displayed to a viewer at for example a same, matching or similar angle as the view captured by imager 100 in 2D image 202.

In some embodiments, 3D image 200 and/or 2 D image 204 that is generated from 3D image 200 may include for example features such as for example occluded or significantly or non-significantly stenosed vessels or vessel trees that were free of or not highlighted by contrast material such as for example contrast materials that may be used in angiography. In some embodiments, image data from 3D image 200 that may define boundaries of a vessel that is free of contrast material may be collected, generated or derived using processes similar to those described in U.S. patent application entitled Device, System and Method for Segmenting Structures in a Series of Images by Adi Mashiach filed on the date of filing of this application and incorporated by reference in its entirety herein. Other methods or processes for collecting image data from a 3D image 200 are possible.

In some embodiments, a processor such as for example processor 108 may generate one or a limited number of 2D images 204 or 3D images from 3D image 200, and such one or limited number of 2D images 204 may match, correspond or be similar to one or a series of angles or views that may be selected for example for capturing 2D image 202, by for example 2D imager 100 such as an angiograph or for example a C-arm 102 of for example an angiograph. The one or limited number of 2D images may be generated for example at or around the time that the user selects for example an angle 109 of for example C-arm 102 of imager 100. In some embodiments, processor 108 may generate and for example store 2D images 204 that may have been derived from 3D image 200, in all or many angles 109 that may match all or many of the possible angles 109 that may be selected by for example a user in a positioning for example C-arm 102 or another component of imager 100.

In some embodiments 2D image 202, as modified or supplemented by the 2D image 204 may be shown instead of or in addition to the 2D image 202. In some embodiments the image data from the two 2D images 202 and 204 may be combined into a single image.

In some embodiments, an instrument such as a probe 120 or other device or a position of a probe 120 that may be for example inserted into a vessel or part of a vessel or body part 107 may be captured in for example a 2D image 202 that may be captured by imager 100. In some embodiments, probe 120 may be inserted into a position in body part 107 such as a blood vessel or a part of a blood vessel that is not for example highlighted by contrast material, or that for other reasons may not be visible on 2D image 202. In some embodiments, the position or location of probe 120 in body part 107 may be determined relative to a vessel or body part that appears in 2D image 204, or for example in a 2D image that may combine image data from 2D image 202 and 2D image 204.

In some embodiments, a part of a vessel that may be free from or not highlighted by contrast material may be or include a part of the vessel that is distal to an occlusion that blocks some or any contrast material from reaching such part of the vessel. In some embodiments, a part of a vessel that may be free from or not highlighted by contrast material may be or include a portion of the vessel where plaque or other material blocks some or any contrast material from reaching the subject part of the vessel. Other causes for a vessel or part of a vessel being free from contrast material are possible.

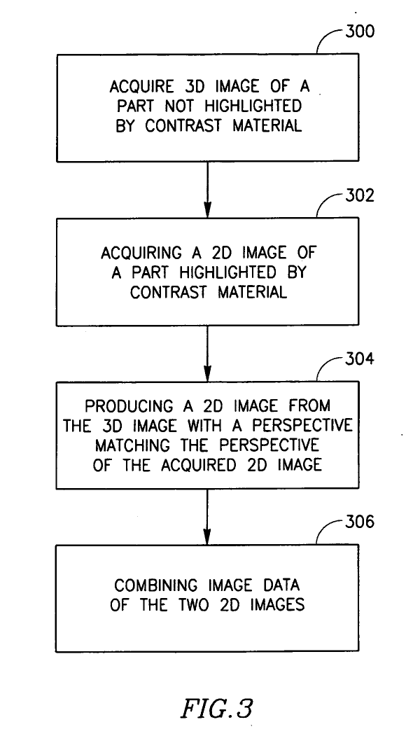

Reference is made to FIG. 3, a flow chart of a method in accordance with an embodiment of the invention. In block 300, an imager such as for example a 3D imager such as a CT scanner, MRI, ultrasound or other imager may capture a 3D image of a body part such as for example a vessel, organ or tubular structure. In some embodiments, the 3D image may include a series of images. In some embodiments the 3D image may be or include an image of a body part or vessel that may be free of contrast material. In some embodiments, a vessel or body part may be segmented from other objects or organs that may appear in the 3D image. In some embodiments, the 3D image may be captured during for example a preoperative stage, and 3D image data may for example be stored in a data storage unit. The 3D image may be captured at other periods.

In block 302, a 2D image may be acquired of for example a body part such as for example a vessel. In some embodiments, the 2D image may be acquired during for example an intra-operative period when for example a patient is undergoing an operative procedure. In some embodiments, the 2D image of such body part or vessel may for example overlap with the image of the part of the body or vessel that was captured in the 3D image in block 300. In some embodiments, the body part or vessel whose image is captured in the 2D image may be highlighted by for example a contrast material that may be injected or otherwise introduced into a body, or that may be otherwise present in a body or body part. In some embodiments, an angle or perspective from which a 2D image was taken, or other indication of a view of the body part as appears in the 2D image, may be for example recorded or otherwise noted. In some embodiments the angle or perspective of the image may be derived from a position or angle of for example a C-arm or other imaging component relative to the body part, at the time that the image is captured. In some embodiments, the angle or perspective of the 2D image may be correlated or otherwise linked with the 2D image, and may be recorded in for example a DICOM format. Other suitable formats may be used.

In block 304, one or more 2D images may be produced from data that may be included in the acquired 3D image described in block 300. In some embodiments, an angle, view or perspective of the 2D image produced from the 3D image may be similar to, match or otherwise be comparable to an angle, view or perspective of a view in the 2D image that was described in block 302. In some embodiments, the matching of the views, angles or perspectives need not be a precise match. In some embodiments, the produced 2D image may include a part of a body part or vessel that is not highlighted by or that is free of contrast material and that may not appear, or may not appear clearly in the acquired 2D image. In some embodiments, many 2D images may be produced from the data in the 3D image, and such 2D images may match all or many of the possible perspectives that may be assumed by the acquiring 2D imager. In some embodiments the produced 2D image may be generated in for example real time during an operative procedure or when a user is acquiring the acquired 2D image.

In some embodiments, the produced 2D image may be registered onto or over the acquired 2D image so that for example one or more points of the acquired 2D image is matched with one or more points of the produced 2D image. In some embodiments, the registration of the image may be performed in an off-line process such as in a pre-operative period. In some embodiments, a user may adjust one or more of the views or images captured by the 2D imager, or the 2D image produced and combined with the captured 2D image data. In some embodiments, different views or combinations of images may be evaluated by a processor, and a user may be presented with the clearest or best view of a particular vessel. In some embodiments, a produced image may be modified, such as stretched, rotated or otherwise altered to fit the view, size or perspective of the captured image.

In some embodiments, a processor may be connected to the captured 3D image, to the 2D imager such as an angiograph and to for example an ECG machine. By analyzing changes to the captured 2D images over the cardiac cycles in the ECG, a morphological alteration may be applied to the produced 2D images to produce a mimic of the movement of the heart in a series of produced 2D images. One method of producing such a series may be to detect markers on the acquired images and track their change in location, such changes could then be applied to the captured 3D images to create a series of produced images matching the movement in a cardiac cycle.

In block 306 and in some embodiments, some or all of the data from the acquired 2D image may be combined with data from the produced 2D image. In some embodiments some or all of the produced 2D image may be for example added to or combined with the acquired 2D image, and a user may be presented with the modified or combined view that shows a part of the vessel that is highlighted by contrast material, and a part of the vessel that may be free of contrast material, or to which such contrast material may not have reached. The presented combined data may be used as a road map for a user to insert and direct a probe or other instrument into or through the vessel or body part. In some embodiments, a user may create multiple views or road maps of one or more vessels or vessel trees. Other combinations or modifications of image data from the acquired 2D image and the produced 2D image are possible. For example, a new image may be generated from the data of the acquired and produced 2D images.

In some embodiments, an instrument or probe may be used during or as part of a procedure where the acquired 2D image is acquired. The probe may be visible in the acquired 2D image, and in some embodiments, the produced 2D image may present the position of for example the vessel or part of a vessel, relative to the probe, so that the probe may be directed into parts of vessels that were not visible on the acquired 2D image.

It will be appreciated by persons skilled in the art that embodiments of the invention are not limited by what has been particularly shown and described hereinabove. Rather the scope of at least one embodiment of the invention is defined by the claims below.

I claim:

1. A method comprising:
acquiring a three dimensional image of a first part of a blood vessel, said first part of said blood vessel free of contrast material;
acquiring a two dimensional image of a second part of said blood vessel, said second part highlighted by contrast material;
producing a two dimensional image of said first part of said blood vessel from said three dimensional image, a perspective of said first part in said two dimensional image of said first part matching a perspective of said two dimensional image of said second part; and
combining image data of said two dimensional image of said second part with image data from said two dimensional image of said first part.

2. The method as in claim 1, wherein said acquiring said three dimensional image of said first part of said blood vessel comprises acquiring said three dimensional image in a pre-operative period; and wherein said acquiring said two dimensional image of said second part comprises acquiring said two dimensional image of said second part in a pre-operative period.

3. The method as in claim 1, wherein said acquiring said three dimensional image of said first part of said blood vessel comprises acquiring said three dimensional image in a pre-operative period; and wherein said acquiring said two dimensional image of said second part comprises acquiring said two dimensional image of said second part in an intra-operative period.

4. The method as in claim 1, comprising recording an angle of an imager that captures said two dimensional image of said second part.

5. The method as in claim 1, comprising recording an angle of a 2D imager relative to said blood vessel.

6. The method as in claim 5, comprising recording said angle in a DICOM format.

7. The method as in claim 1, wherein producing said two dimensional image of said first part comprises producing a plurality of said two dimensional images of said first part, wherein at least one of said plurality of two dimensional images of said first parts corresponds to a possible perspective of said two dimensional image of said second part.

8. The method as in claim 1, comprising registering said two dimensional image of said first part with said two dimensional image of said second part.

9. The method as in claim 1, comprising displaying a position of an instrument, said instrument disposed in said first part.

10. The method as in claim 1, comprising displaying image data resulting from said combining image data of said two dimensional image of said second part with image data from said two dimensional image of said first part.

11. A system comprising a processor to:
acquire a three dimensional image of a first part of a blood vessel, said first part of said blood vessel free of contrast material,
acquire a two dimensional image of a second part of said blood vessel, said second part highlighted by contrast material;
produce a two dimensional image of said first part of said blood vessel from said three dimensional image, a perspective of said first part in said two dimensional image of said first part matching a perspective of said two dimensional image of said second part; and
combine image data of said two dimensional image of said second part with image data from said two dimensional image of said first part.

12. The system as in claim 11, wherein acquiring said three dimensional image of said first part of said blood vessel comprises acquiring said three dimensional image in a pre-operative period; and wherein said acquiring said two dimensional image of said second part comprises acquiring said two dimensional image of said second part in a pre-operative period.

13. The system as in claim 11, wherein said acquiring said three dimensional image of said first part of said blood vessel comprises acquiring said three dimensional image in a pre-operative period; and wherein said acquiring said two dimensional image of said second part comprises acquiring said two dimensional image of said second part in an intra-operative period.

14. The system as in claim 11, wherein said processor is to record an angle of an imager that captures said two dimensional image of said second part.

15. The system as in claim 11, wherein said processor is to record an angle of a 2D imager relative to said blood vessel.

16. The system as in claim 15, wherein said processor is to record said angle in a DICOM format.

17. The system as in claim 11, wherein said producing said two dimensional image of said first part comprises producing a plurality of said two dimensional images of said first part, wherein at least one of said plurality of two dimensional images of said first part corresponds to a possible perspective of said two dimensional image of said second part.

18. The system as in claim 11, wherein said processor is to register said two dimensional image of said first part with said two dimensional image of said second part.

19. The system as in claim 11, wherein said processor is to display a position of an instrument, said instrument disposed in said first part.

20. The system as in claim 11, wherein said processor is to display image data resulting from said combining image data of said two dimensional image of said second part with image data from said two dimensional image of said first part.

21. An article having stored thereon computer readable instructions, that when executed result in:
acquiring a first three dimensional image of a first part of a blood vessel, said first part of said blood vessel free of contrast material;
acquiring a two dimensional image of a second part of said blood vessel, said second part highlighted by contrast material;
producing a second three dimensional image of said first part of said blood vessel from said first three dimensional image, a perspective of said first part in said second three dimensional image of said first part matching a perspective of said two dimensional image of said second part; and
combining image data of said two dimensional image of said second part with image data from said second three dimensional image of said first part.

22. The article as in claim 21, wherein said instructions further result in registering said second three dimensional image of said first part with said two dimensional image of said second part.

23. The article as in claim 21, wherein said instructions further result in displaying a position of an instrument, said instrument disposed in said first part.
